(19) United States
(12) Patent Application Publication
(10) Pub. No.: US 2011/0045236 A1
(43) Pub. Date: Feb. 24, 2011

(54) Building board for handling and use

(76) Inventors: Mark Thomas Fisher, (US); Gregory Kimm, (US); Noel Araracap Dones, Rancho Cucamonga, CA (US); Chinmay Avinash Gowardhan, Fontana, CA (US); John Donarummo, JR., Rancho Cucamonga, CA (US)

Correspondence Address: James Hardie Technology Limited;Europa House, Harcourt Centre, Harcourt Centre, Dublin, DUBLIN 2, IE

(21) Appl. No.: 12/854,134

(22) Filed: Aug. 10, 2010

Related U.S. Application Data
(60) Provisional application No. 61/232,693, filed on Aug. 10, 2009.

(51) Int. Cl. B32B 3/10

(52) U.S. Cl. 428/131

(57) ABSTRACT

Described herein are articles for handling and use that include one or more spaces in predetermined and select locations. The one or more spaces may be more centrally located, on the edges of the article, on opposite edges of the article or in one or more positions that aid in handling and use of the article. The shaped spaces may be in any form, wherein simple shapes are more cost effective, such as those that resemble a square, rectangular, circle or oval.

### CROSS-REFERENCE TO RELATED APPLICATION

This application claims the benefit for priority purposes from U.S. Provisional Application No. 61/232,693 filed Aug. 10, 2009, which is incorporated herein by reference in its entirety for all purposes.

### BACKGROUND OF THE INVENTION

The invention relates generally to cementitious articles fabricated as an article, such as in the form of a sheet, board or panel, for interior or exterior use and further configured in a way for ease of handling, moving, assembly and/or storage.

Building articles, such as ones for use in construction, may be heavy and cumbersome to lift or carry. To move such articles, they are often lifted manually and transported in such a manner from one place to another, particularly before or during a construction period. Workers or those involved in handling, lifting and/or transporting said building articles often remove only one article from a unit or stack and position each one article individually in place for further use or for installation.

### SUMMARY OF THE INVENTION

In one or more embodiments described herein are building articles, often in the form of a board, sheet or panel, for use in construction of buildings. Said articles may be selected from those used in building construction, such as a cementitious article with or without fiber reinforcement, or may be made of gypsum, wood or a wood composite, a polymer or polymer composite, or may be a medium density fiberboard, all of which are provided as non-limiting examples. Articles may be designed for use as a panel, sheet, tile underlay, soffit or for other suitable building purposes.

Articles described herein further comprise one or more spaces, often as complete of incomplete holes and/or as complete or incomplete cut out spaces or slots in predetermined positions, and have one or more characteristic configurations. When shaped regions are punched out, they may be inserted back at a later time.

In one form is an article having one or more spaces shaped during formation of the article. In another form is an article having one or more spaces shaped by a water jet when the article is not fully formed. In still another form is an article having one or more spaces shaped by a water jet when the article is in a green state before hardening takes place.

One or more embodiments disclosed herein include a building article comprising one or more spaces in predetermined positions and have one or more characteristic configurations. In some embodiments, the cut out shapes are less than about 2%, preferably less than about 10%, of the total article area. In some embodiments, the cut out spaces are at least 0.5″ diameter, preferably 0.7″ diameter, allowing at least the handler's finger to grip through. In some embodiments, if one dimension of the cut out shape is greater than 1.5″, the other dimension of the cut out shape is not greater than 1″. This will allow enough space for fingers in one hand to grip on but not too much unused space cut out. In some other embodiments, the cut out spaces are thin slots, allowing a different material to hook through to create a handle.

The cut out spaces may be complete and span a thickness of the article. In addition, some or all of the spaces may be incomplete and do not span an entire thickness of the article. The article may be the form of one of a board, sheet or panel. The article may be a material selected from the group consisting of cementitious, fiber-cement, gypsum, wood, wood composite, a polymer composite, and medium density fiberboard. The article may be in the form of one of a tile, tile underlay or soffit. The spaces may be cut outs. The cut-outs may be repositioned in the article after initially being removed for a period of time. The spaces may be shaped during formation of the article. The spaces may be shaped after the article is in a green state. The spaces may be shaped by a water jet applied to the article when the article is not fully cured.

In a further form is a method of fabricating an article having one or more spaces, such as a fully formed or partially formed hole or slots, wherein the one or more spaces are shaped when the article is not fully formed. When a water jet is used to form the space, the water jet is generally positioned at a less than 90° angle to the article's upper surface and directed inward towards what is considered the interior space. In additional embodiments, a water jet, when used, forms the space and is generally positioned at a less than 90° angle to the article's upper surface and directed inward towards what is considered the center of the space.

Additional embodiments described herein include a method of fabricating an article having one or more spaces comprising the steps of preparing an article that is not fully cured, applying water to a first surface of the article at one or more specific locations, wherein the water forms a shape on the first surface of the article but does not form a shape on a second surface of the article, and curing the article. The water may be in the form of a jet stream. The water may be positioned at an angle that is less than 90 degrees to the first surface. The water may be directed inward towards what is considered the center of the shaped region. The shaped region may be punched out after the article is cured. The water forms tabs on the first surface that mark a boundary of the shaped region. One or more of the punched out tabs may be inserted back at a later time.

Those skilled in the art will further appreciate the above-noted features and advantages of the invention together with other important embodiments thereof upon reading the detailed description that follows and in conjunction with the drawings.

### BRIEF DESCRIPTION OF THE DRAWINGS

For more complete understanding, reference is now made to a description of one or more embodiments of the invention along with accompanying figures, wherein:

FIG. 1A is a schematic and representative embodiment of articles described herein having one or more spaces in a predetermined position, each in a characteristic configuration.

FIG. 1B is a schematic and representative embodiment of an article wherein one or more spaces are positioned and shaped to provide a location for adding an external handle.

FIG. 1C to FIG. 1H inclusive are schematic and representative embodiments of articles described herein having one or more spaces in a predetermined position, each in a characteristic configuration.

### DETAILED DESCRIPTION OF THE INVENTION

Although making and using various embodiments are discussed in detail below, it should be appreciated that as described herein are provided many inventive concepts that may be embodied in a wide variety of contexts. Embodiments discussed herein are merely illustrative of ways to make and use the invention, and do not limit the scope of the invention.

The drawing figures are not necessarily to scale and certain features may be shown exaggerated in scale or in somewhat generalized or schematic form in the interest of clarity and conciseness.

Generally, as described herein are articles having one or more shaped spaces in one or more predetermined positions. Said spaces are shaped in one or more characteristic configurations for handling. The shapes are generally selected from the group including square, rectangular, round, and oval. Additional shapes may be suitable; however, simple shapes as described herein are generally easier and less time consuming to fabricate. There may be one space or a number of spaces on each article. Said spaces may fully or partially span the article. The shapes are generally provided by removing all or a portion within the shaped region. In one form, the shapes may be formed by cutting or by other means known in the art to remove material from an article described herein. Removal of the predetermined portion, defined by the shape, generally occurs when the article is not fully formed. For certain articles, the article is in a green state. In other articles, the shaping of the space occurs prior to curing. In addition or as an alternative, the shaping and removal of all or a portion of the space may occur via molding during the manufacturing process. Still further, the one or more shaped spaced may be removed or cut out after curing or fully forming the article.

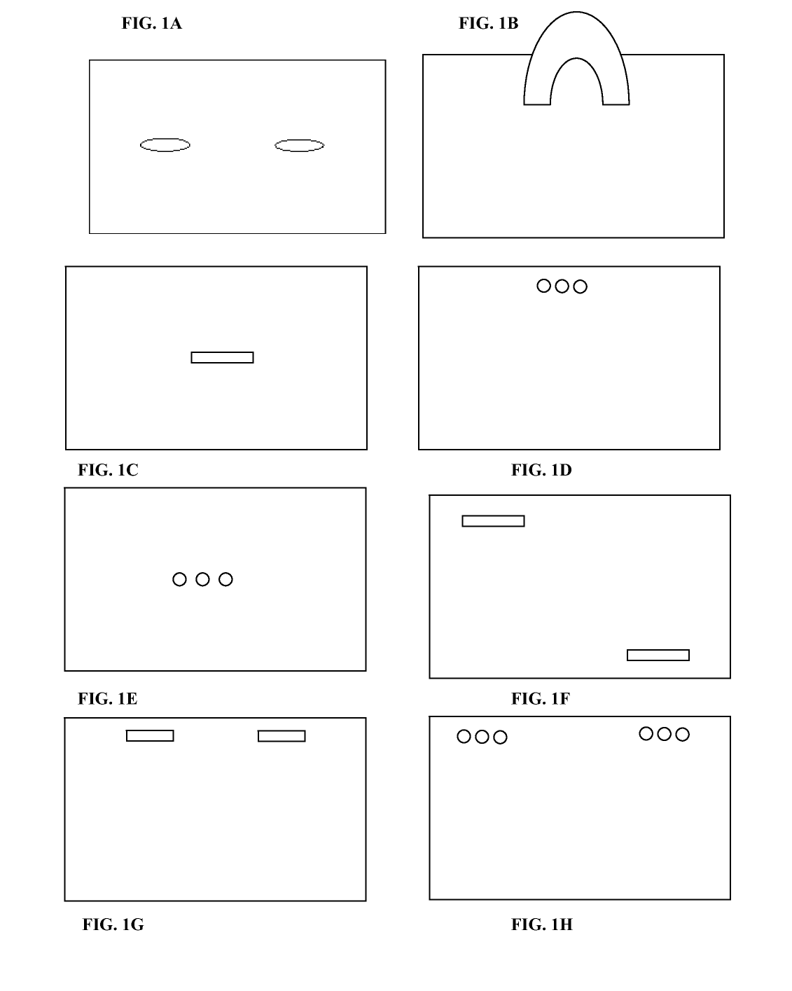

Shaped spaces are generally located in predetermined positions. Examples of suitable positions include but are not limited to: a central area of the article, near one or more edges of the article, or at a suitable distance from the edge that facilitates lifting and/or transportation of the article. Combinations thereof may also be useful for larger articles or those that are difficult to maneuver or transport. Representative spaces and shapes are depicted in FIGS. 1A and 1C-1H.

In some embodiments, building articles are fiber reinforced cement panels, sold as prefabricated products with cut-outs or slots in them. Building articles such as panels or tile underlays are conventionally made as intact pieces, made to be flat, smooth, without cuts or surface defect. It is generally believed that any cuts or surface defects may negatively impact the functional purpose of the article, such as providing a continuous bonding surface for tiles. However, current inventors unexpectedly found that small cuts or slots can be designed with certain size and shapes on building articles so that they do not influence the performance of the building articles. Furthermore, the cuts and slots can be designed at strategic locations, providing lifting access such as the handler's fingers or hands on the product, allowing the article to be lifted and handled with ease. On a construction site, this will allow installers or builders to use the building articles with ease, fast installation and safety.

Spaces as described herein are specifically shaped and designed to preserve the structural integrity of the article. While the spaces may be placed in one of a number of positions, the location of the one or more holes is often selected so as to not interfere with the general application and use of the article. For example, for an articles used as a tile underlay or tile backer, shaped spaces may be positioned specifically on only one surface or in a position that does not affect title adhesion and/or bonding. In some cases, the one or more spaces are predetermined and positioned so that the shape and location will facilitate attachment of a temporary external handle, as depicted in FIG. 1B. One or more embodiments disclosed herein include a building article comprising one or more spaces in predetermined positions and have one or more characteristic configurations.

In some embodiments, the cut out shapes are less than about 2%, preferably less than about 10%, of the total article area. In some embodiments, the cut out spaces are at least 0.5″ diameter, preferably 0.7″ diameter, allowing at least the handler's finger to grip through. In some embodiments, if one dimension of the cut out shape is greater than 1.5″, the other dimension of the cut out shape is not greater than 1″. This will allow enough space for fingers in one hand to grip on but not too much unused space cut out. In some other embodiments, the cut out spaces are thin slots, allowing a different material to hook through to create a handle.

In one example, a fabricated board was designed to have two spaces, each space or region spanning the thickness of the board and cut-out along a center-line relying on a short direction located at ⅓ and ⅔ of the board length. Two shaped regions, each rectangular in nature, were made on the board prior to being fully cured and after it was formed as a green sheet using a high powered water jet. The water jet stream was at an angle (generally less than 90° to the board's upper surface) and was set inward towards what would be considered the center of the spaced region. The water jet cut the top surface of the board and most of the way through the green sheet and provided tabs on the top surface that marked the boundaries of the hole, which remained in place until a later time. The green sheet after shaping was subsequently cured. After curing and when the two holes were needed, the tabbed portions of each region were punched out from the back (opposite) surface and the tabbed inserts were released, thereby providing two through holes in the fabricated board. The punched out portions or inserts could optionally and as desired be placed back (akin to a wedge) at a later time, such as after installation, regardless of how the fabricated board was installed or treated. The tabs as well as when placed back as inserts are amenable to any further treatments suitable to such a board, such as texturing, painting, embossing, as representative examples.

In another example, one or more shaped regions are made on a panel before the panel is fully cured and after it is in a green state. A high powered water jet with a fine stream is used to generate the shaped region only on one surface of the panel. The water jet forms cuts that penetrate the one surface but only less than or about 50% through the panel thickness. The green sheet is then further processed and fully cured. After curing, the shaped regions are removed but holes form only on the one surface and not through the entire thickness, thus forming. The portions removed may be later filled in or replaced, such as after installation and the full panel may be further treated as desired to form a fully finished panel.

Articles having one or more shaped spaces as described herein, thus, offer a means for handling the articles on or before installation. Although the foregoing description of certain preferred embodiments has shown, described and pointed out the fundamental novel features of the invention, it will be understood that various omissions, substitutions, and changes in the form of the detail of the invention as illustrated as well as the uses thereof, may be made by those skilled in the art, without departing from the spirit of the invention. Consequently, the scope of the invention should not be limited to the foregoing discussions.

What is claimed is:

1. An article of manufacture comprising cementitious based sheet, board or panel used in building construction, said cementitious based sheet having at least one cut out shape, said cut out shape being less than 10% of the cementitious based sheet, board or panel surface area, with said cut out shape having its smallest dimension being between 0.2″ to 1.5″ in length.

2. An article of manufacture in claim 1, wherein said cut out shape has its smallest dimension being between 0.2″ to 1.0″ in length.

3. An article of manufacture in claim 1, wherein said cut out shape has its smallest diameter being 0.5″ to 1.0″ in diameter.

4. An article of manufacture in claim 4, wherein said cut out shape has its smallest diameter being 0.7″ in diameter.

5. An article of manufacture in claim 1, said cut out shape is less than 2% of the total cementitious based sheet, board or panel surface area.

6. An article of manufacture in claim 1, wherein said cementitious based sheet, board or panel is fiber reinforced.

7. An article of manufacture in claim 1, wherein said cementitious based sheet, board or panel consisting of cementitious, fiber-cement, gypsum, wood, wood composite, a polymer composite, or medium density fiberboard.
